(19) United States
(12) Patent Application Publication
(10) Pub. No.: US 2016/0369552 A1
(43) Pub. Date: Dec. 22, 2016

(54) Insulated Glass, Through-Glass Handle Mounting Spacer

(71) Applicant: Gary Sprague, Los Angeles, CA (US)

(72) Inventor: Gary Sprague, Los Angeles, CA (US)

(73) Assignee: C.R. Laurence Co., Inc., Los Angeles, CA (US)

(21) Appl. No.: 14/743,862

(22) Filed: Jun. 18, 2015

(51) Int. Cl. E06B 3/663; E06B 3/667; E05B 1/00

(52) U.S. Cl. CPC E06B 3/66304; E05B 1/00; E06B 3/667

(57) ABSTRACT

A spacer for the through-glass mounting of door handles on insulated glass doors is presented. Through-glass mounting of opposing inner and outer door handles on insulated glass doors provides the handles with a “floating” on the glass appearance which is much desired by purchasers of such doors. The present invention spacer serves to reinforce the two, spaced apart, glass panes which comprise an insulated glass door in the region where through-the-glass mounting of opposing inner and outer door handles, is desired, The spacer features compression lips and sealing surfaces on each side of the spacer, as well as alignment flanges located about the interior periphery of the spacer and farther includes gaps between the alignment flanges, all of which aid in the construction of a mounting location on an insulated glass door.

### FIELD OF THE INVENTION

The present invention relates generally to spacers for use in the construction of insulated glass doors, and more particularly, to spacers for use in the through-glass mounting of handles for insulated glass doors.

### BACKGROUND OF THE INVENTION

Swinging glass doors have been a popular feature of commercial and multi-dwelling residential buildings for several decades. Many such door designs comprise a frameless door featuring a single pane of heavy glass with the door hinges and handles mounted directly to the single glass pane. The door handles are typically of a mutually opposed design, i.e. inner and outer door handles that directly face each other and are mounted to the glass pane via a bolt which passes through a hole in the glass. In these handle arrangements, a nut or nut-plate is incorporated within one of the handles and a cover arrangement for hiding the bolt is incorporated in the other handle. This arrangement also typically incorporates a bushing to prevent the bolt from bearing directly on the door glass. This type of handle arrangement has proven to be aesthetically pleasing and popular because the handles appear to be “floating” on the glass.

In recent years, due to an ongoing need to increase energy efficiency, double pane glass doors, commonly referred to as insulated glass doors have begun to gain in popularity for exterior applications. Insulated glass doors comprise two panes of glass which are separated, or spaced apart, about their perimeter by spacers sandwiched between the panes. Insulated glass doors, with their dual pane configuration having a sealed air space between the panes, have proven to be substantially more energy efficient than single pane glass doors. In some instances, the energy efficiency of insulated glass doors may be farther Improved by filling the interior volume with an insulating gas.

Dual pane glass doors have certain, primarily aesthetic, drawbacks when compared to single pane glass doors. In particular, the exposed edges of the panes and separating spacers are unsightly and therefore must be covered. The coverings typically comprise horizontal rails and vertical stiles, typically of stainless steel. With regard to handles, the individual panes of insulated glass doors are too thin to support through-glass mounted handles. Therefore, handles for insulated glass doors have typically been mounted on the vertical stiles. Mounting the handles on a vertical stile requires that a relatively wide stile be used on the free end of the swinging glass door.

Although the “handle on the stile” mounting configuration used in insulated glass doors is not unattractive, nevertheless, it does not provide the aesthetically pleasing and much sought after “floating on the glass” appearance of through-glass mounted handles. Therefore, there is a need in the art for hardware that will allow through-glass mounting of door handles on insulated glass doors.

SUMMARY OF THE INVENTION

The mounting spacer of the present invention allows for the through-glass mounting of opposing inner and outer door handles on insulated glass doors such that the handles appear to be “floating” on the glass. The spacer of the present invention is sandwiched between the two, spaced apart, panes of glass which comprise insulated glass doors. The spacer serves to reinforce the panes in the region where a hole or cutout has been made for passage of a through-bolt, which is required for the through-glass mounting of opposing inner and outer door handles.

In one embodiment, the spacer is generally round or donut-shaped and is used for reinforcing circular holes in insulated glass doors. In another embodiment, the spacer has a generally oval region for reinforcing oval cutouts in insulated glass doors. In both embodiments, the spacer features compression lips and sealing surfaces oil each side of the spacer, as well as alignment flanges located about an inner periphery of the spacer and further includes gaps between the alignment flanges.

The compression lips function to prevent excessive compression of the sealing surfaces of the spacer and of a primary sealant applied to the sealing surfaces. The alignment flanges serve in conjunction with an alignment dowel to align the spacer about a hole to be reinforced during assembly of an insulated glass door panel. Once an insulated glass door panel has been assembled, the alignment dowel is removed from the panel and a moisture or water resistant secondary adhesive is applied about the inside periphery of the spacer to seal the spacer/glass panel interface against moisture intrusion. The gaps in the alignment flange of the spacer allow for the secondary adhesive to readily flow to both sides of the spacer, regardless of on which side the adhesive is applied.

One presently preferred material for the spacer is polycarbonate, colored with carbon-black for UV resistance. Polycarbonate is well-suited to the present application because of its ease of manufacture via injection molding and because it is compatible with both polyisobutylene sealant (“PB sealant”) and silicone sealants, both of which are commonly used as primary and secondary sealants, respectively, in the construction of insulated glass doors.

The above and other features of the invention will become more apparent from the following detailed description.

### BRIEF DESCRIPTION OF THE DRAWINGS

FIG. 1 is a top plan view of a spacer for the through-glass mounting of handles on insulted glass doors, in accordance with the present invention.

FIG. 2 is a side view of the spacer for the through-glass mounting of handles on insulted glass doors of FIG. 1.

FIG. 3 is a side sectional view along the line 3-3 of FIG. 2 of the spacer for the through-glass mounting of handles on insulted glass doors of the present invention.

FIG. 4 is a schematic view showing the installation of the spacer of the present invention in an insulated glass door.

FIG. 5 is a schematic view showing the spacer of the present invention partially installed in an insulated glass door.

FIG. 6 is a schematic view showing the spacer of the present invention fully installed in an insulated glass door.

FIG. 7 is a schematic view of a door handle assembly installed on an insulated glass door using the spacer of the present invention.

FIG. 8 is a top plan view of an alternative embodiment of the spacer for the through-glass mounting of handles on insulted glass doors, of the present invention.

FIG. 9 is a side sectional view along toe line 9-9 of FIG. 8 of the alternative embodiment of the spacer for the through-glass mounting of handles on insulted glass doors of the present invention.

### DETAILED DESCRIPTION OF TEE PREFERRED EMBODIMENTS

The present invention will now be described more fully hereinafter with reference to the accompanying drawings, in which preferred embodiments of the invention are shown. The invention may, however, may be embodied in many different forms and should not be construed as being limited to the embodiments set forth herein. Rather these embodiments are provided so that this disclosure will be thorough and complete, and will fully convey the scope of the invention to those skilled in the art. Like numbers refer to like elements throughout.

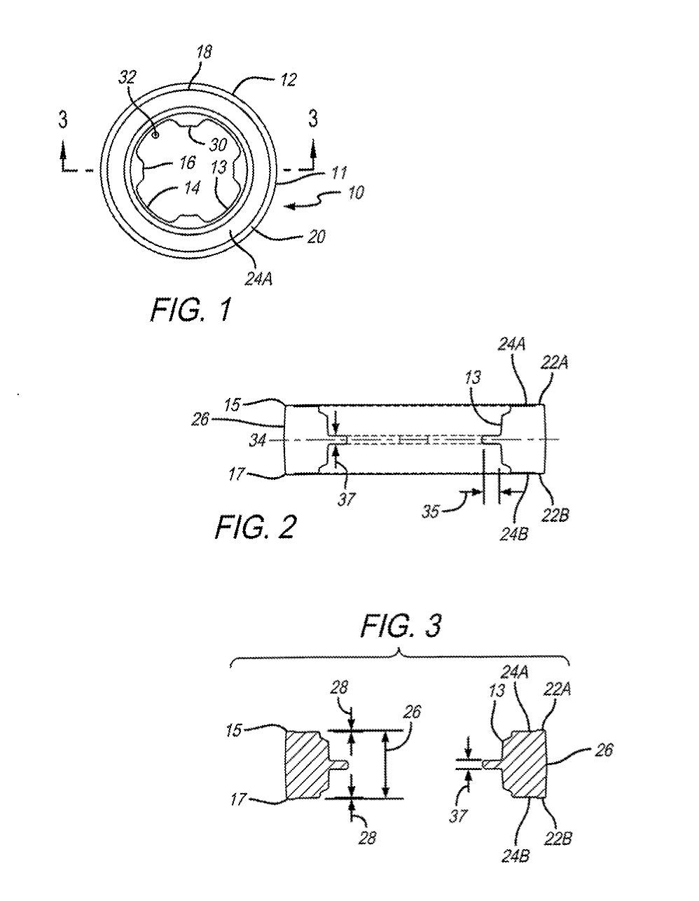

With reference to FIGS. 1-3, a spacer 10 for the through-glass mounting of handles on insulated glass doors is shown. Glass doors suitable for use with the spacer 10 of the present invention will typically feature two panes of glass separated or spaced apart by a frame-work composed of spacers disposed between the glass panes about the perimeter of the panes. The embodiment of the spacer 10 of the present invention shown in FIGS. 1-3 is intended for use with through-glass mounted door handles which utilize a through-bolt which passes tough round holes or penetrations in the glass panes which comprise insulated glass doors. The principles described herein may be broadly applied to other spacer shapes, as may be needed by any particular door handle installation.

With continued reference to FIGS. 1-3, the spacer 10 includes a spacer body 11 of generally cylindrical or donut-like construction. The spacer body 11 includes an inner periphery 13, defined by an inside diameter 14, and planar sides 15 and 17. The spacer body 11 is generally defined by an outside diameter 12, the inside diameter 14, and a principle width 26. The spacer body 11 further includes an alignment flange diameter 16, an outer sealing surface diameter 20, and a radial lip diameter 18.

The outside diameter 12 and radial lip diameter 18 of the spacer body 11 define a radial compression lip 22A , therebetween, on the planar side 15. Similarly, the outside diameter 12 and the radial lip diameter 18 define a radial compression lip 22B, therebetween, on the planar side 17. The upper and lower radial compression lips 22A and 22B, each have a thickness 28. The radial compression lip diameter 18 and the sealing surface diameter 20 define a sealing surface 24A, therebetween, on the planar side 15. Similarly, the radial compression lip diameter 18 and the sealing surface diameter 20 define a sealing surface 24B, therebetween, on the planar side 17.

The spacer body 11 of the present invention spacer 10 also includes a plurality of radially inwardly facing alignment flanges 30. The alignment flanges 30 are centered about a midpoint plane 34 (see FIG. 2) of the principal width 26 and extend inwardly from the inner periphery 13. The alignment flanges 30 have a predetermined depth 35 and are of a predetermined thickness 37. In the exemplary embodiment, the spacer body 11 includes four of the alignment flanges 30, evenly spaced about the inner periphery 13. The spacer body 11 further includes a plurality of gaps 32 disposed between each of the alignment flanges 30.

In the exemplary embodiment, the spacer 10 is made from polycarbonate material. Polycarbonate is well suited to this application because it is compatible with polyisobutylene sealant (“PB sealant”), as well as with silicone sealants, both of which are commonly used in insulated glass door construction. PB sealant is an extrudable (hot melt application) thermoplastic material which adheres well to both polycarbonate and glass, and is moisture resistant. Silicone sealant is a barrier sealant featuring excellent resistance to moisture penetration, PB sealant and several types of suitable silicone sealants are commercially available from multiple sources.

In the exemplary embodiment, the polycarbonate material of the spacer 10 is colored with carbon-black, a colorant material, which enhances the UV resistance of the polycarbonate material. Polycarbonate and carbon-black are well-known materials, readily available from a number of commercial sources. While polycarbonate is the presently preferred material, a variety of other plastic based materials are also suitable. The spacer 10 of the present invention is not limited to any particular type of material.

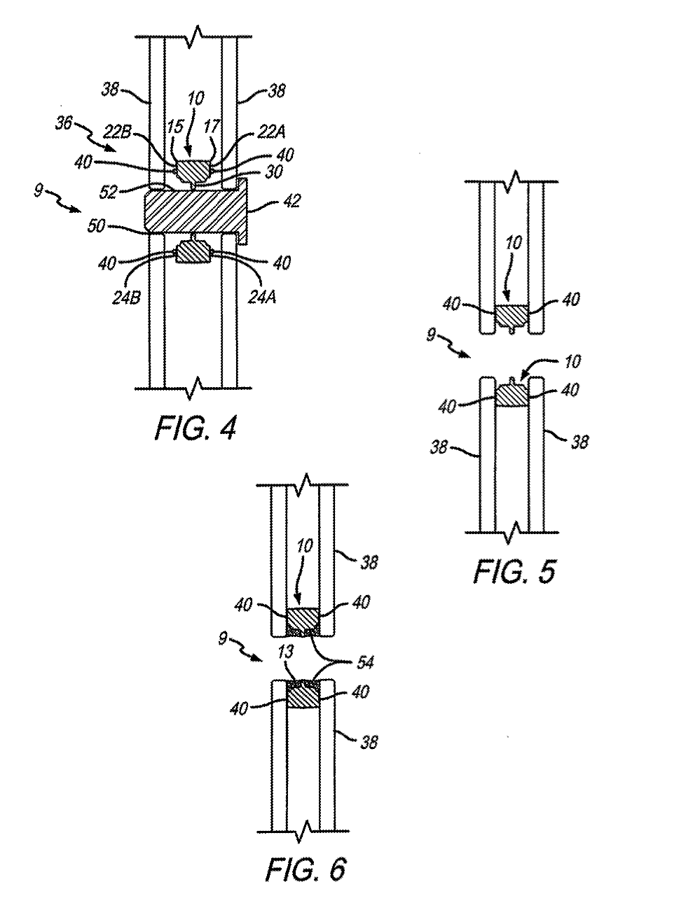

Referring now to FIGS. 4-6, the construction of a typical door handle mount 9 using the spacer of the present invention 10 in an insulated glass door 36 is shown. The insulated glass door 36 comprises two panes or lites 38 of glass. Formed within each pane 38 are axially aligned holes 50. During fabrication of the glass door 36, the spacer 10 of the present invention is disposed between the panes 38 and is aligned with the axially aligned holes 50 in the panes 38 by means of an alignment dowel 42. The alignment dowel 42 has an outside diameter 52 which is configured to be a slip fit with the alignment flange diameter 16 (see FIG. 1) of the spacer 10.

Prior to insertion and alignment of the spacer 10 with the holes 50 in the glass panes 38, a circular bead 40 of sealant (PB Sealant) is placed about the sealing surfaces 24A and 24B of the planar sides 15 and 17 of the spacer 10. Thereafter, the glass panes 38 are compressed against the spacer 10 for a predetermined period of time until the sealant 40 has cured. (It is to be understood that contemporaneously with the insertion of the spacer 10, an interior perimeter frame composed of spacers (not shown) is also inserted between the glass panes 38, with suitable adhesive.)

The radial lips 22A and 22B of the planar sides 15 and 17 of the spacer 10 serve to prevent excessive compression of the sealing surfaces 24A and 24B. Excessive compression of the sealing surfaces 24A and 24B may cause the sealant 40 to squeeze out between the sealing surfaces 24A and 24B and the glass panes 38, leaving too little sealant at the interface between the sealing surfaces and glass panes to form a sufficiently strong bond at the spacer/glass interface.

With reference to FIG. 5, the spacer 10 of the present invention is shown installed between the two glass panes 38 which comprise the insulated glass door 36. With reference to FIG. 6, the construction of the handle mount 9 using the spacer of the present invention 10 is completed by disposing a layer of secondary sealant 54 about the inner periphery 13 of the spacer 10. The secondary sealant 54 will typically be a moisture resistive or barrier sealant. In the exemplary embodiment, silicone sealant, which is essentially moisture proof, is used as the secondary sealant 54.

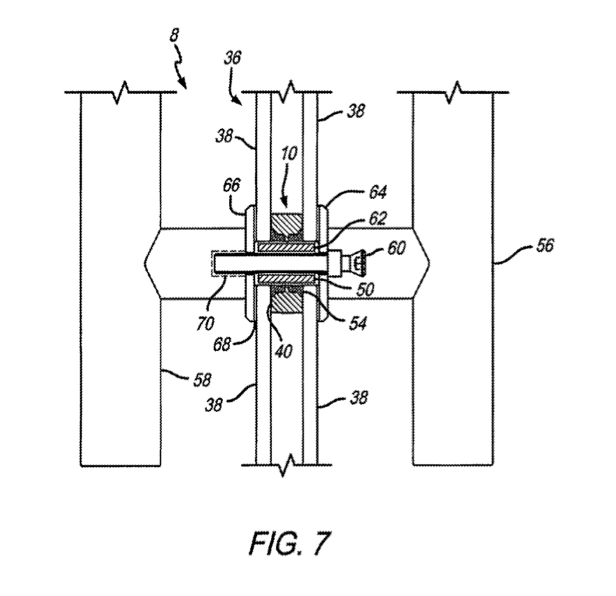

Referring now to FIG. 7, an exemplary door handle installation 8 using the spacer of the present invention 10 is depicted in schematic form. In a typical installation, an inner door handle 56 and an outer door handle 58, having respective mounting flanges 64 and 66, are mounted to the panes 38 of an insulated glass door 36, which has previously had the spacer of the present invention 10 installed about the through-holes 50 in the glass panes 38.

The inner and outer door handles 56 and 58 are secured to the panes 38 of the insulated glass door 36, as follows. A cylindrical bushing 62, typically of plastic and configured to be a slip fit with the holes 50 in the glass panes 38, is inserted through the panes 38 via the axially aligned holes 50. Next, the inner and outer door handles 56 and 58 are positioned about the axially aligned holes 50 wherein washers 68, typically of plastic, serve as a non-marring interface between the mounting flanges 64 and 66 of the inner and outer door handles 56 and 58, respectively. Subsequently, the bolt 60 is inserted through one of the door handles and engages with an internally threaded engaging portion 70 of the opposed door handle. Tightening of the bolt 60 secures the inner and outer door handles 56 and 58 to the insulated glass door 36. In typical handle designs, the attachment bolt 60 will be hidden from view. The completed assembly gives the appearance of the door handles “floating on the glass,” which is presently a much desired aesthetic appearance.

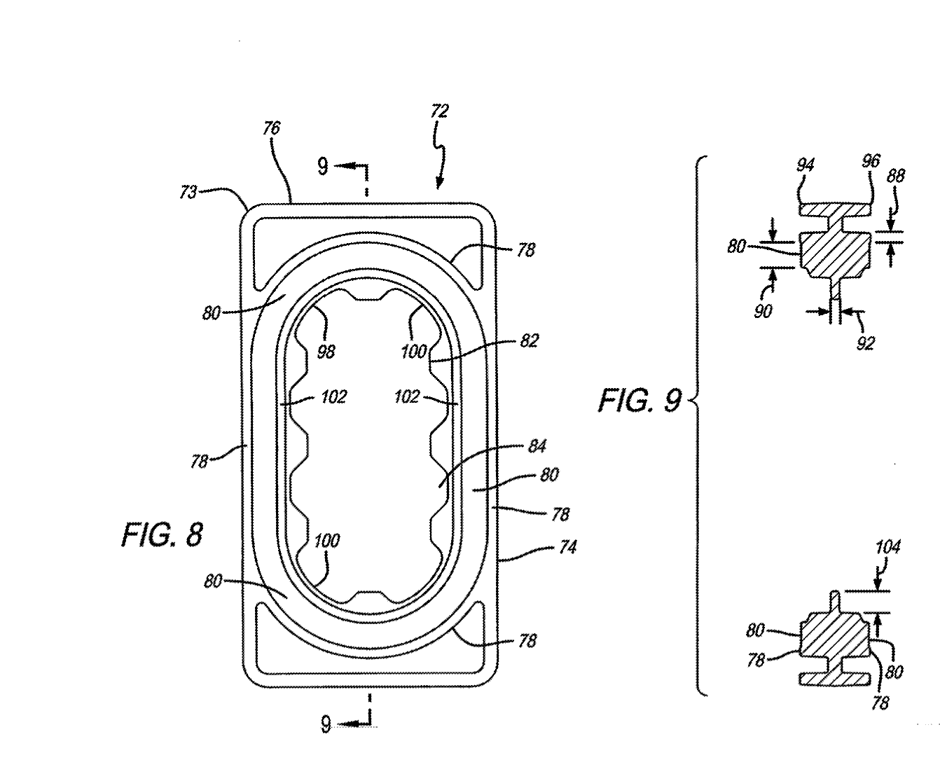

Referring now to FIGS. 8-9, another embodiment of a spacer, hereinafter rectangular spacer 72, in accordance with the present invention, is presented. Rectangular spacer 72 is for use with insulated glass doors having generally oval or race-track-like cutouts or penetrations in the glass panes. The rectangular spacer 72 has a spacer body 73 having a generally rectangular exterior shape defined by width 76 and length 74, as well as a planar side 94, a planar side 96, and an inner periphery 98. (See FIG. 9.)

The rectangular spacer body 73 also includes a generally oval or race-track-like compression lip 78 disposed on each of the planar sides 94 and 96, each compression lip 78 having a width 88. The rectangular spacer body 73 additionally includes a generally oval or race-track-like sealing surface 80, also disposed on each of the planar sides 94 and 96, each sealing surface 80 having a width 90. The rectangular spacer body 73 farther includes a plurality of alignment flanges 82, each alignment flange 82 extending inwardly from the inner periphery 98 and having a thickness 92 and a depth 94. Disposed between each adjacent alignment flange 82 is one of plurality of gaps 84.

In the exemplary embodiment of FIGS. 8-9, the inner periphery 98 is defined by generally semicircular end sections 100 which are interconnected by generally straight sections 102. The term “race-track-like” as used in this specification, for example to define the compression lips 78 and sealing surfaces 80, refers to a shape having generally semicircular end sections interconnected by generally straight sections.

The rectangular spacer 72 functions similarly to spacer 10, i.e. the compression lips 78 prevent over-compression of the sealing surfaces 80 and sealant 40 (see FIG. 7) disposed thereon, by the glass panes 38 during assembly of the insulated glass door 36. Likewise, an oval or race-track-like alignment dowel (not shown) is used to align the rectangular spacer 72 with an oval or race-track-like cutout (not shown) in the panes 38 of the insulated glass door 36, via the plurality of alignment flanges 82, during assembly of the door 36. Upon removal of the oval or race-track-like alignment dowel, secondary sealant 54 (see FIG. 7) is applied about the inner periphery 98 to seal interfaces between the planer sides 94 and 96 of the rectangular spacer 72 and the glass panes 38. The gaps 84 allow the secondary sealant 54 to readily reach both sides of the rectangular spacer 72.

Like the spacer 10, the preferred material for the rectangular spacer 72 is polycarbonate colored with carbon-black. A variety of other plastic materials are also suitable.

The foregoing detailed description and appended drawings are intended as a description of the presently preferred embodiments of the invention and are not intended to represent the only forms In which the present invention may be constructed and/or utilized. Those skilled in the art will understand that modifications and alternative embodiments of the present invention which do not depart from the spirit and scope of the foregoing specification and drawings, and of the claims appended below are possible and practical. It is intended that the claims cover ail such modifications and alternative embodiments.

1. A spacer for the through-glass mounting of handles on insulated glass doors, comprising:
a hollow cylindrical spacer body, having a midpoint plane, as inner periphery and two planar sides;
wherein the hollow cylindrical spacer body includes a compression lip disposed along each of the planar sides;
wherein the hollow cylindrical spacer body includes a sealing surface disposed along each of the planar sides;
wherein a plurality of alignment flanges extend inwardly a predetermined distance from the inner periphery and are parallel to and centered about the midpoint plane of the hollow cylindrical spacer body;
wherein the each of the plurality of alignment flanges includes an arcuate surface defined by an alignment flange diameter;
wherein a gap is disposed between each of the plurality of the alignment flanges;
wherein each gap includes an arcuate surface defined by an inside diameter.

2. The spacer for the through-glass mounting of handles on insulated glass doors of claim 1, wherein the compression lip on each of the planar sides extends radially about the planar side.

3. The spacer for the through glass mounting of handles on insulated glass doors of claim 1, wherein the sealing surface on each of the planar sides extends radially about the planar side.

4. The spacer for the through-glass mounting of handles on insulated glass doors of claim 1, wherein the sealing surface on each of the planar sides is disposed adjacent to and extends radially inwardly from the compression lip also disposed on each planar side.

5. The spacer for the through-glass mounting of handles on insulated glass doors of claim 1, wherein the plurality of alignment flanges extend inwardly from the inner periphery at a midpoint between the two planar sides of the hollow, cylindrical spacer body.

6. The spacer for the through-glass mounting of handles on insulated glass doors of claim 1, wherein the spacer body is composed of polycarbonate.

7. The spacer for the through-glass mounting of handles on insulated glass doors of claim 6, wherein the polycarbonate is colored with carbon-black.

8. A spacer for the through-glass mounting of handles on insulated glass doors, comprising;
a body portion, having a midpoint plane, a generally oval inner periphery and two planar sides;
wherein the body portion includes a generally oval compression lip disposed about each of the planar sides;
wherein the body portion includes a generally oval sealing surface disposed about each of the planar sides;
wherein a plurality of alignment flanges extend inwardly a predetermined distance from the inner periphery and are parallel to the midpoint plane of the body portion;
wherein a gap is disposed between each of the plurality of the alignment flanges; and
wherein each of the alignment flanges is connected to the each adjacent gap by sloping sides.

9. The spacer for the through-glass mounting of handles on insulated glass doors of claim 8, wherein the generally oval sealing surface on each of the sides of the spacer is disposed adjacent to and extends inwardly from the generally oval compression lip also disposed on each of the planar sides.

10. The spacer for the through-glass mounting of handles on insulated glass doors of claim 8, wherein the generally oval inner periphery, compression lips and sealing surfaces of the body portion are configured to have semi-circular end portions interconnected by straight portions.

11. The spacer for the through-glass mounting of handles on insulated glass doors of claim 8, wherein the body portion is composed of polycarbonate.

12. The spacer tor the through-glass mounting of handles on insulated glass doors of claim 8, wherein the plurality of alignment flanges extend inwardly from the inner periphery at a midpoint between the two planar sides of the body portion.

13. A spacer for the through-glass mounting of handles on insulated glass doors, comprising:
a spacer body, having a midpoint plane, an inner periphery and two planar sides;
wherein the spacer body includes a compression lip disposed about each of the planar sides;
wherein the spacer body includes a sealing surface disposed about each of the planar sides;
wherein a plurality of alignment flanges extend inwardly a predetermined distance from the inner periphery and are parallel to the midpoint plane of the spacer body;
wherein a gap is disposed between each of the plurality of the alignment flanges; and
wherein each of the alignment flanges is connected to each adjacent gap by means of sloping sides.

14. The spacer for the through-glass mounting of handles on insulated glass doors of claim 13, wherein the inner periphery of the spacer body is generally circular.

15. The spacer for the through-glass mounting of handles on insulated glass doors of claim 13, wherein the timer periphery of the spacer body has semi-circular end portions interconnected by straight portions.

16. The spacer for the through-glass mounting of handles on insulated glass doors of claim 13, wherein the sealing surface on each of the sides of the spacer body is disposed adjacent to and extends inwardly from the compression lip also disposed on each of the planar sides.

17. The spacer for the through-glass mounting of handles on insulated glass doors of claim 13, wherein the spacer body is composed of polycarbonate.

18. The spacer for the through-glass mounting of handles on insulated glass doors of claim 13, wherein the plurality of alignment flanges extend inwardly from the inner periphery at a midpoint between the two planar sides of the body portion.

19. A mount for the through-glass mounting of handles on insulated glass doors, comprising:
two spaced apart glass panes, each glass pane including a through-hole, the through-holes in the glass panes being axially aligned;
a spacer disposed between the glass panes and about the through-holes;
the spacer comprising, a spacer body, having a midpoint plane, an inner periphery and two planar sides, wherein the spacer body includes a compression lip and a sealing surface disposed about each of the planar sides, and a plurality of alignment flanges which extend inwardly a predetermined distance from the inner periphery and are parallel to the midpoint plane, wherein each of the plurality of alignment flanges includes an arcuate surface defined by an alignment flange diameter; and
wherein a gap is disposed between each of the plurality of the alignment flanges;
wherein each gap includes an arcuate surface defined by an inside diameter;
wherein each sealing surface on each of the planar sides abuts one of the glass panes; and
wherein the spacer is secured to the glass panes by a primary adhesive applied to the sealing surfaces;
inner and outer door handles disposed about the through-holes; and
a bolt disposed through the through-holes interconnecting the inner and outer door handles.

20. The mounting for the through-glass mounting of handles on insulated glass doors of claim 19, wherein the plurality of alignment flanges extend inwardly from the inner periphery at a midpoint between the two planar sides of the spacer body.

21. The spacer for the through-glass mounting of handles on insulated glass doors of claim 1, wherein the arcuate inward surface of each alignment flange transitions via a radius to the arcuate inward surface of each gap.

22. The spacer for the through-glass mounting of handles on insulated glass doors of claim 19, wherein the arcuate inward surface of each alignment flange transitions via a radius to the arcuate inward surface of each gap.
